(19) United States
(12) Patent Application Publication
(10) Pub. No.: US 2018/0162619 A1
(43) Pub. Date: Jun. 14, 2018

(54) MEDICAL DEVICE PACKAGING WITH OPENING FEATURE

(71) Applicant: BOSTON SCIENTIFIC SCIMED, INC., Maple Grove, MN (US)

(72) Inventors: GORDON JOHN KOCUR, LINO LAKES, MN (US); MEDHA TYAGI, DELHI (IN)

(73) Assignee: BOSTON SCIENTIFIC SCIMED, INC., MAPLE GROVE, MN (US)

(21) Appl. No.: 15/841,220

(22) Filed: Dec. 13, 2017

Related U.S. Application Data
(60) Provisional application No. 62/433,768, filed on Dec. 13, 2016.

(51) Int. Cl. B65D 75/58; B65D 5/54; B65B 55/12

(52) U.S. Cl. CPC B65D 75/5805; A61J 1/00; B65B 55/12; B65D 5/54

(57) ABSTRACT

Medical device packages may be configured to be easily openable in dark locations such as but not limited to cardiac catheter labs and surgical suites. Medical device packages may be configured to be more easily opened by including features that help to instruct a user where to grasp the medical device package, present a grip feature to quickly separate and grasp the two layers to be separated and provide texture on the grip to improve grip and control of the packaging and the sterile product within the packaging during transfer to a sterile surgical field or user, for example. In some cases, medical device packages may be configured to facilitate cooperation between a user opening the package outside of a sterile field and a user within the sterile field accepting the medical device disposed within the medical device package.

### CROSS-REFERENCE TO RELATED APPLICATIONS

This application claims the benefit of priority under 35 U.S.C. § 119 to U.S. Provisional Application Ser. No. 62/433,768, filed Dec. 13, 2016, the entirety of which is incorporated herein by reference.

### TECHNICAL FIELD

The disclosure is directed to packaging and more particularly to packaging for medical devices, including packaging for medical devices that may be sterilized within the packaging.

### BACKGROUND

A number of medical devices may be provided within packaging that protects the medical devices and keeps the medical devices clean and sterile prior to use. In some cases, opening the packaging involves a cooperation between someone outside of a sterile field and someone within a sterile field. Controlled opening of the package can be important. For example, the person outside of the sterile field may contact an exterior of the packaging and may be responsible for opening the packaging without contacting the contents of the packaging. The person within the sterile field, for example, may receive the contents without contacting the exterior of the packaging. Of the known packaging and packaging methods, each has certain advantages and disadvantages. There is an ongoing need to provide alternate packaging for medical devices as well as alternate methods for manufacturing and using medical device packaging.

### SUMMARY

The disclosure is directed to several alternative designs, materials and methods of manufacturing medical device packaging, and uses thereof. For example, the disclosure is directed to a medical device package that is configured to accommodate a medical device therein. The medical device packaging includes a back package portion and a front package portion that is releasably secured to the back package portion. The front package portion may include a release feature that is secured to the front package portion as well as a visual indicator that is coupled to the release feature and that facilitates easy identification of the release feature. The back package portion may be configured to provide a holding feature to facilitate holding onto the back package portion while pulling on the release feature in order to peel the front package portion away from the back package portion in order to provide access to the medical device disposed within the medical device package.

Alternatively or additionally to any of the embodiments above, the medical device package may further include a medical device disposed within the medical device package.

Alternatively or additionally to any of the embodiments above, the medical device may be a guidewire or a catheter.

Alternatively or additionally to any of the embodiments above, the front package portion may further include a textured surface coupled to the release feature in order to facilitate grasping the release feature.

Alternatively or additionally to any of the embodiments above, the back package portion may further include a textured surface disposed proximate the release feature of the front package portion in order to facilitate holding the back package portion when pulling on the release feature.

Alternatively or additionally to any of the embodiments above, the back package portion may further include a region of the back package portion extending beyond a periphery of the front package portion.

Alternatively or additionally to any of the embodiments above, the front package portion may include a polymeric panel, and the release feature may include a corner of the polymeric panel folded back over itself to form a flap.

Alternatively or additionally to any of the embodiments above, the flap may be secured in place relative to the front package portion with an adhesive disposed between the flap and the front package panel.

Alternatively or additionally to any of the embodiments above, the flap may be pressed into place relative to the front package portion by crimping the flap.

Alternatively or additionally to any of the embodiments above, the medical device package may further include a clip that is configured to hold the flap down, the clip secured relative to the front package portion.

Alternatively or additionally to any of the embodiments above, the back package portion may include a polymeric panel.

Alternatively or additionally to any of the embodiments above, the back package portion may include a polymeric tray.

The disclosure is also directed to a package for holding a medical device that is sterilizable while within the package. The package includes a first package portion and a second package portion that is releasably secured to the first package portion, with the first package portion and the second package portion in combination defining a space within which the medical device may be disposed. At least one of the first package portion and the second package portion may include a release feature that facilitates separation of the first package portion from the second package portion in order to provide access to the medical device and that provides a visual indication of how to separate the first package portion from the second package portion.

Alternatively or additionally to any of the embodiments above, the release feature may further provide an element to facilitate grasping at least one of the first package portion and the second package portion.

Alternatively or additionally to any of the embodiments above, the release feature may further provide a first element to facilitate grasping the first package portion and a second element to facilitate grasping the second package portion.

Alternatively or additionally to any of the embodiments above, at least one of the first package portion and the second package portion may include an aluminum foil.

Alternatively or additionally to any of the embodiments above, at least one of the first package portion and the second package portion may include a polymeric panel.

Alternatively or additionally to any of the embodiments above, at least one of the first package portion and the second package portion may include spun polyethylene fibers.

The disclosure is also directed to a package for holding an article. The package includes a first package portion and a second package portion that is releasably secured to the first package portion, with the first package portion and the second package portion in combination defining a space within which the article may be disposed. At least one of the first package portion and the second package portion may include a feature facilitating separation of the first package portion from the second package portion in order to provide access to the article, the feature providing a visual indication of how to separate the first package portion from the second package portion.

Alternatively or additionally to any of the embodiments above, the feature may further provide an element to facilitate grasping at least one of the first package portion and the second package portion.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE FIGURES

The disclosure may be more completely understood in consideration of the following description of in connection with the accompanying drawings, in which:

FIG. 1 is a schematic illustration of a medical device package in accordance with an embodiment of the disclosure;

FIG. 2 is a schematic illustration of a medical device package in accordance with an embodiment of the disclosure;

FIG. 3 is a schematic illustration of a medical device package in accordance with an embodiment of the disclosure;

FIG. 4 is a schematic illustration of a portion of a medical device package in accordance with an embodiment of the disclosure;

FIG. 5 is a schematic illustration of a portion of a medical device package in accordance with an embodiment of the disclosure;

FIG. 6 is a schematic illustration of a portion of a medical device package in accordance with an embodiment of the disclosure;

FIG. 7 is a schematic illustration of a portion of a medical device package in accordance with an embodiment of the disclosure;

FIG. 8 is a schematic illustration of a portion of a medical device package in accordance with an embodiment of the disclosure;

FIG. 9 is a schematic illustration of a portion of a medical device package in accordance with an embodiment of the disclosure;

FIG. 10 is a schematic illustration of a medical device package in accordance with an embodiment of the disclosure;

FIG. 11 is a schematic illustration of the medical device package of FIG. 10, shown open;

FIG. 12 is a schematic illustration of a medical device package in accordance with an embodiment of the disclosure;

FIG. 13 is a schematic illustration of a medical device package in accordance with an embodiment of the disclosure;

FIG. 14 is a schematic illustration of a medical device package in accordance with an embodiment of the disclosure;

FIG. 15 is a schematic illustration of a medical device package in accordance with an embodiment of the disclosure;

FIG. 16 is a schematic illustration of a medical device package in accordance with an embodiment of the disclosure;

FIG. 17 is a schematic illustration of a medical device package in accordance with an embodiment of the disclosure;

FIG. 18 is a schematic illustration of a medical device package in accordance with an embodiment of the disclosure;

FIG. 19 is a schematic illustration of a medical device package in accordance with an embodiment of the disclosure;

FIG. 20 is a schematic illustration of a medical device package in accordance with an embodiment of the disclosure;

FIG. 21 is a view of a portion of the medical device package of FIG. 20;

FIG. 22 is a schematic illustration of a medical device package in accordance with an embodiment of the disclosure;

FIG. 23 is a schematic illustration of a medical device package in accordance with an embodiment of the disclosure;

FIG. 24 is a side view of the medical device package of FIG. 23.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DESCRIPTION

For the following defined terms, these definitions shall be applied, unless a different definition is given in the claims or elsewhere in this specification.

Definitions of certain terms are provided below and shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the disclosure. The illustrative embodiments depicted are intended only as exemplary. Selected features of any illustrative embodiment may be incorporated into an additional embodiment unless clearly stated to the contrary.

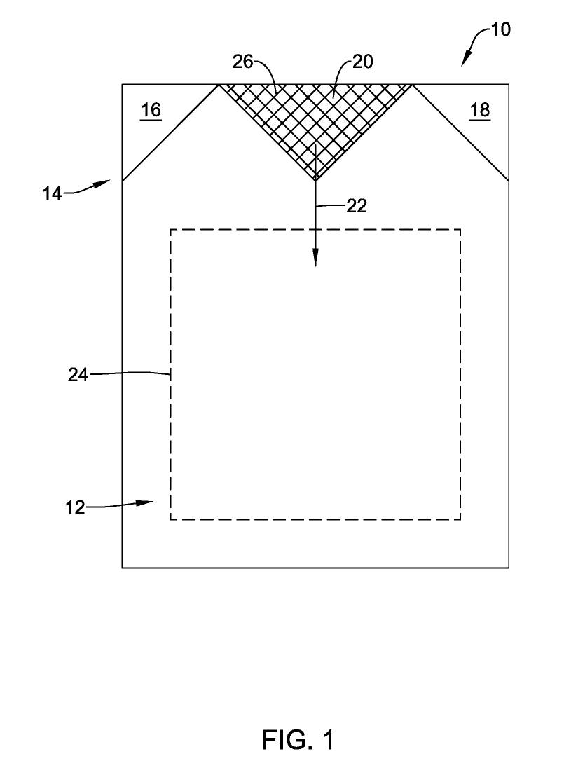

FIG. 1 through FIG. 3 provide illustrative but non-limiting examples of medical device packaging that may be considered to be foil pouches, formed by sealing together two sheets or panels of a foil such as but not limited to aluminum foil. FIG. 1 through FIG. 3 provide examples of different configurations or styles of release features that may be used to facilitate opening the pouch. In FIG. 1, a medical device package 10 includes a first package portion 12 and a second package portion 14. In some cases, the first package portion 12 may be considered as being a front package portion while the second package portion 14 may be considered to be a back package portion, but this is not required in all cases. In some cases, at least some of the first package portion 12 may be adhesively secured around its perimeter to the second package portion 14. In some cases, the first package portion 12 and the second package portion 14 may be formed by folding over a single piece of material such as an aluminum foil and then adhering together the unattached edges of the first package portion 12 and the second package portion 14.

In some cases, the first package portion 12 may have one or more corners removed in order to expose one or more corners of the second package portion 14. As illustrated, the two upper corners of the first package portion 12 have been removed in order to expose a first corner 16 and a second corner 18 of the second package portion 14. In some cases, the exposed first corner 16 and/or the second corner 18 may be considered as being one or more elements that facilitate grasping the second package portion 14. A release feature 20 may be seen secured at or near a top of the medical device package 10.

As will be discussed with respect to subsequent Figures, the release feature 20 may be formed as part of the first package portion 12 or may be separately formed and subsequently secured relative to the first package portion 12. The release feature 20 may be pulled downward, in a direction indicated by an arrow 22, in order to separate the first package portion 12 or a fraction thereof from the second package portion 14 in order to provide access to a medical device 24 shown in phantom. In some cases, the medical device 24 may be a catheter or a guidewire, for example.

In some cases, the release feature 20 may include a visual indicator 26 secured relative to the release feature 20. The visual indicator 26 may, for example, include a pattern or color that helps to distinguish the release feature 20 from the rest of the first package portion 12. In some cases, the visual indicator 26 may be printed or otherwise formed directly on the release feature 20. In some cases, the visual indicator 26 may be secured to the release feature 20. In some instances, the visual indicator 26 may include a textural component, such as raised characters or a raised pattern that helps a user locate the release feature 20. In some cases, the textural component may include parallel raised features that help an individual to grasp the release feature 20. The textural component may be formed by adhering a raised feature onto the release feature 20. In some cases, the textural component may be added by processing the release feature 20, such as but not limited to embossing.

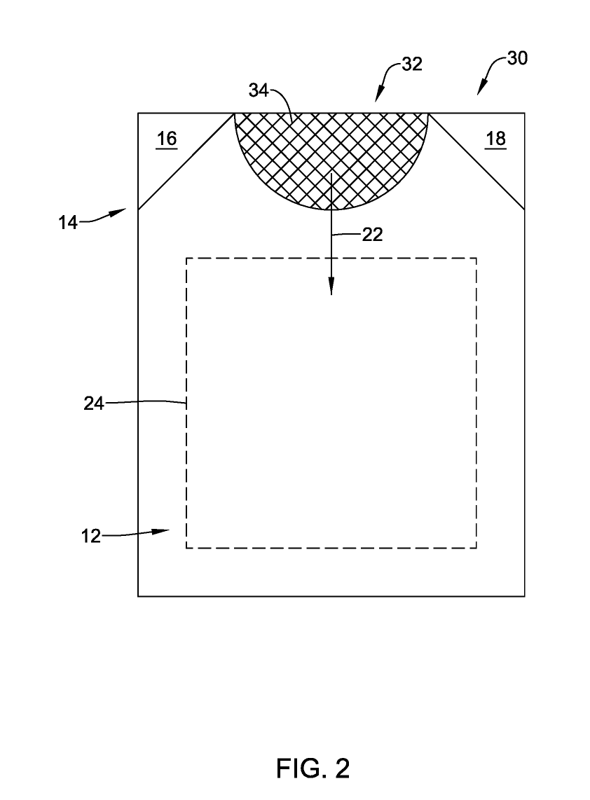

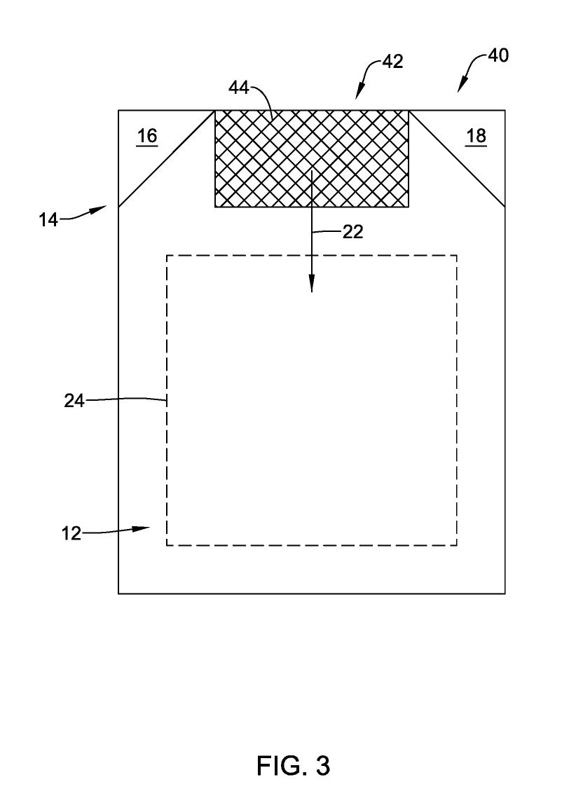

In some cases, the release feature 20 has a first dimension that is in the range of about 1 inch to about 3 inches and a second dimension orthogonal to the first dimension that is in the range of about 1 inch to about 3 inches. In some instances, the first dimension and the second dimension may each be in the range of about 1 inch to about 2 inches. It will be appreciated that the release feature 20 has dimensions that enable the release feature 20 to be easily grasped between thumb and index finger. In FIG. 1, the release feature 20 may be seen as having a triangular shape. FIG. 2 and FIG. 3 illustrate medical device packages having different configuration for the release feature. It will be appreciated that the illustrated configurations are merely illustrative, as other shapes are contemplated as well.

In FIG. 2, a medical device package 30 is similar to the medical device package 10 shown in FIG. 1, although the medical device package 30 has a release feature 32 having a rounded or semicircular profile. In some cases, the release feature 32 may be formed as part of the first package portion 12 or may be separately formed and subsequently secured relative to the first package portion 12. The release feature 32 may be pulled downward, in a direction indicated by an arrow 22, in order to separate the first package portion 12 or a fraction thereof from the second package portion 14 in order to provide access to the medical device 24, shown in phantom.

In some cases, the release feature 32 may include a visual indicator 34 secured relative to the release feature 32. The visual indicator 34 may, for example, include a pattern or color that helps to distinguish the release feature 32 from the rest of the first package portion 12. In some cases, the visual indicator 34 may be printed or otherwise formed directly on the release feature 32. In some cases, the visual indicator 34 may be secured to the release feature 32. In some instances, the visual indicator 34 may include a textural component, such as raised characters or a raised pattern that helps a user locate the release feature 32. The textural component may be formed by adhering a raised feature onto the release feature 32. In some cases, the textural component may be added by processing the release feature 32, such as but not limited to embossing.

FIG. 3 shows a medical device package 40 that is similar to the medical device package 10 shown in FIG. 1, although the medical device package 40 has a release feature 42 having a rectilinear profile. In some cases, the release feature 42 may be formed as part of the first package portion 12 or may be separately formed and subsequently secured relative to the first package portion 12. The release feature 42 may be pulled downward, in a direction indicated by an arrow 22, in order to separate the first package portion 12 or a fraction thereof from the second package portion 14 in order to provide access to the medical device 24, shown in phantom.

In some cases, the release feature 42 may include a visual indicator 44 secured relative to the release feature 42. The visual indicator 44 may, for example, include a pattern or color that helps to distinguish the release feature 42 from the rest of the first package portion 12. In some cases, the visual indicator 44 may be printed or otherwise formed directly on the release feature 42. In some cases, the visual indicator 44 may be secured to the release feature 42. In some instances, the visual indicator 44 may include a textural component, such as raised characters or a raised pattern that helps a user locate the release feature 42. The textural component may be formed by adhering a raised feature onto the release feature 42. In some cases, the textural component may be added by processing the release feature 42, such as but not limited to embossing.

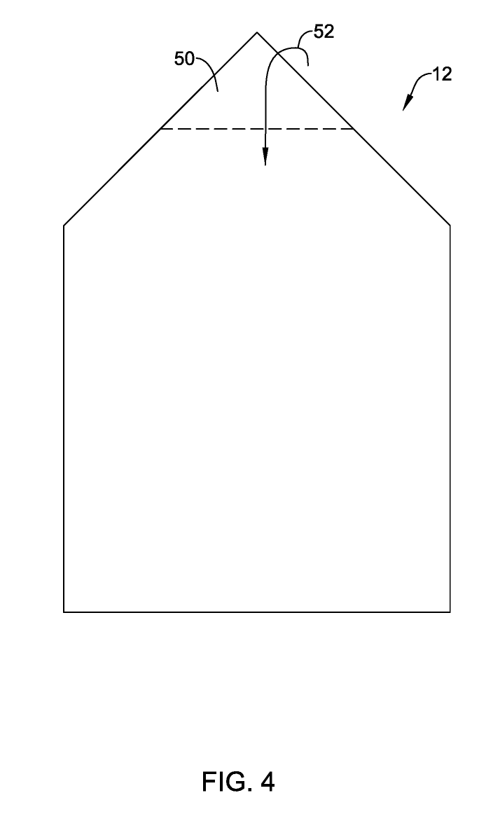

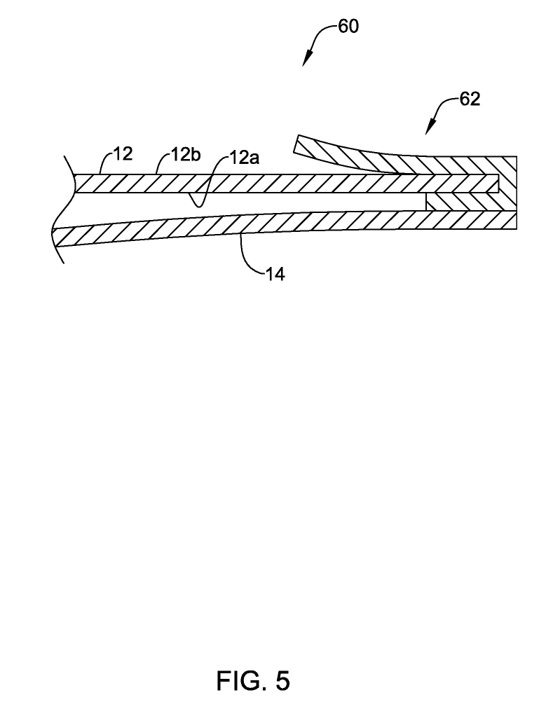

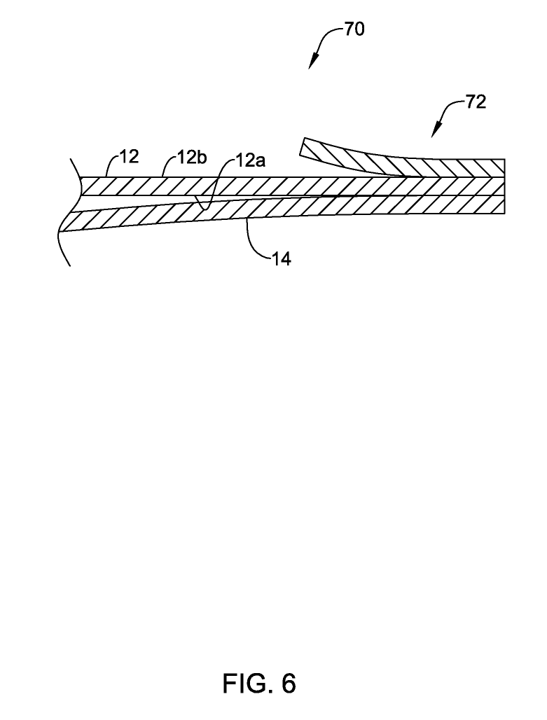

The release features shown in FIG. 1 through FIG. 3 may be formed in a variety of different ways. In some cases, as illustrated for example in FIG. 4, a release feature such as the release feature 20, 32, 42 may be formed by cutting or otherwise forming the first package portion 12 to include a release feature blank 50 that may be bent or folded over in a direction indicated by an arrow 52 to form the release feature 20, 32, 42. While the release feature blank 50 is illustrated as having a triangular profile, it will be appreciated that the release feature blank 50 may be formed with a rounded or semicircular profile, a rectilinear profile, or any other desired shape or configuration. In some cases, the release feature may be separately formed and then subsequently secured relative to the first package portion 12. FIG. 5 and FIG. 6 show illustrative but non-limiting ways of attaching a release feature.

FIG. 5 shows a portion of a medical device package 60 having a release feature 62. As shown, the release feature 62 may be secured to a back side 12a of the first package portion 12 and may wrap around over a front side 12b. In some cases, the release feature 62 may be adhesively secured to the first package portion 12, either just to the back side 12a or to both the back side 12a and the front side 12b. In some cases, the release feature 62 may be crimped or otherwise mechanically coupled to the first package portion 12. In FIG. 6, a release feature 72 may be adhesive secured to the front side 12b of the first package portion 12. Any suitable adhesive may be used, although in some cases hot melt, pressure sensitive and/or liquid adhesives may be used. Examples of suitable hot melt adhesives include but are not limited to metallocene, EVA (ethylene vinyl acetate), polypropylene and polyethylene. Examples of suitable pressure sensitive adhesives include but are not limited to acrylates, butyl rubbers, styrene block polymers, silicone rubbers, nitriles and natural rubbers. Examples of suitable liquid adhesives include but are not limited to acrylic, cyanoacrylic epoxy, PVA (poly vinyl acetate), urethane, dextrin, starches and UV curable materials.

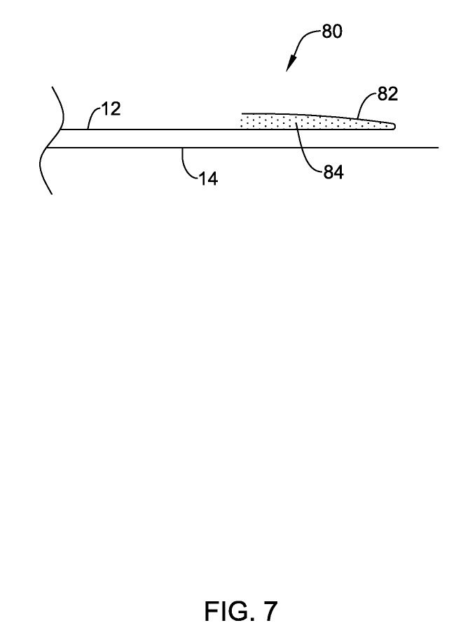

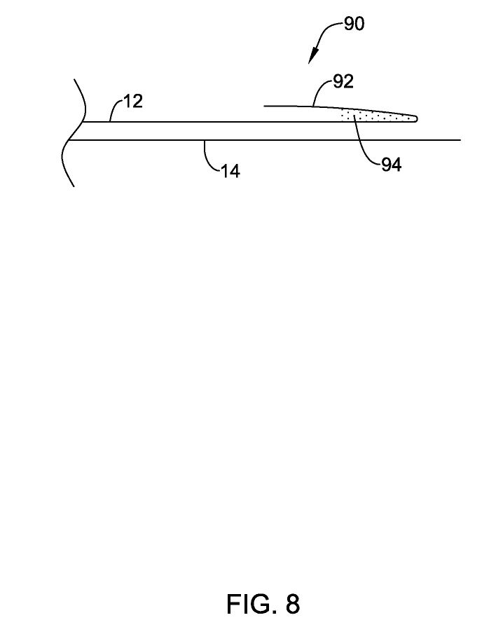

Once a release feature has been formed, in some cases there may be a desire for the release feature to be easily engaged to open a medical device package while reducing a risk of the release feature being accidently engaged. FIG. 7 through FIG. 9 show illustrative but non-limiting techniques for reducing the risk of accidentally engaging the release feature and thus reducing the risk of accidently opening or partially opening the medical device package. FIG. 7 shows a portion of a medical device package 80 that includes a release feature 82 extending from the first package portion 12. As illustrated, an adhesive 84 fills all or substantially all of the space between the release feature 82 and the rest of the first package portion 12. In some cases, the adhesive 84 may be a low strength adhesive that holds the release feature 82 in place against accidental engagement yet yields to applied force when a user grasps the release feature 82 and pulls in order to open the medical device package 80. Suitable low strength adhesives include pressure sensitive adhesives, hot melt peelable films, polypropylene and/or polyethylene. In FIG. 8, a medical device package 90 includes a release feature 92 extending from the first package portion 12. An adhesive 94 fills only part of the space between the release feature 92 and the rest of the first package portion 12.

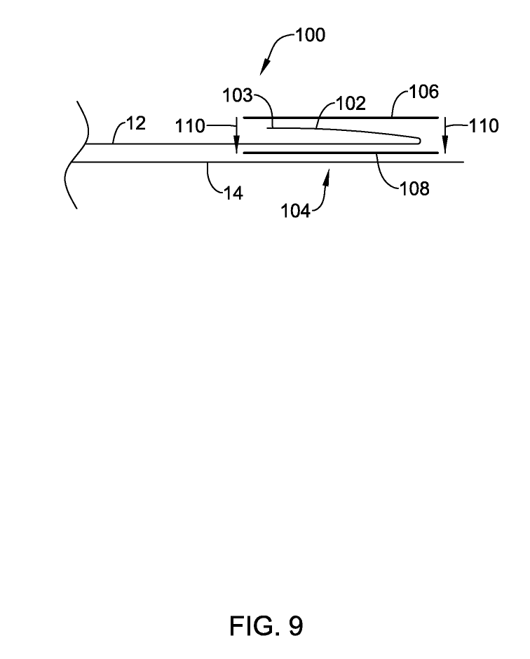

In some cases, as shown for example in FIG. 9, a release feature, once formed, may be crimped or otherwise mechanically processed such that the release feature is a flap that is in close proximity to the first package portion 12. FIG. 9 shows a portion of a medical device package 100 having a release feature 102 with a flap 103. A press 104, including an upper plate 106 and a lower plate 108, is schematically illustrated. In some cases, moving the upper plate 106 towards the lower plate 108, in a direction indicated by arrows 110, may help to crease the flap 103 and thus cause the release feature 102 to lie close to the first package portion 12. In some cases, the release feature may be processed by folding the flap 103 over, and then running a hard object over the edge of the flap, in much the same way as someone might fold a piece of paper over and crease it with their thumbnail in order to obtain a more accurate tear.

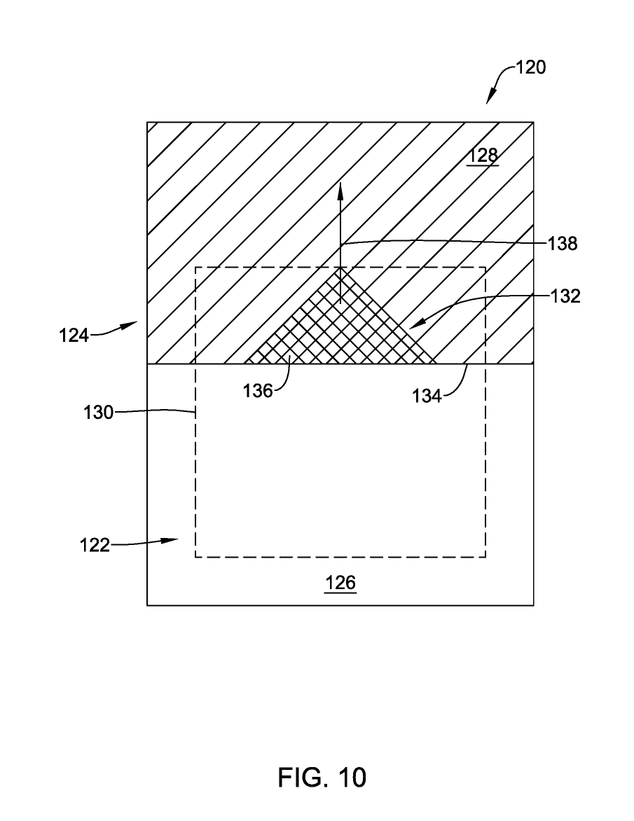

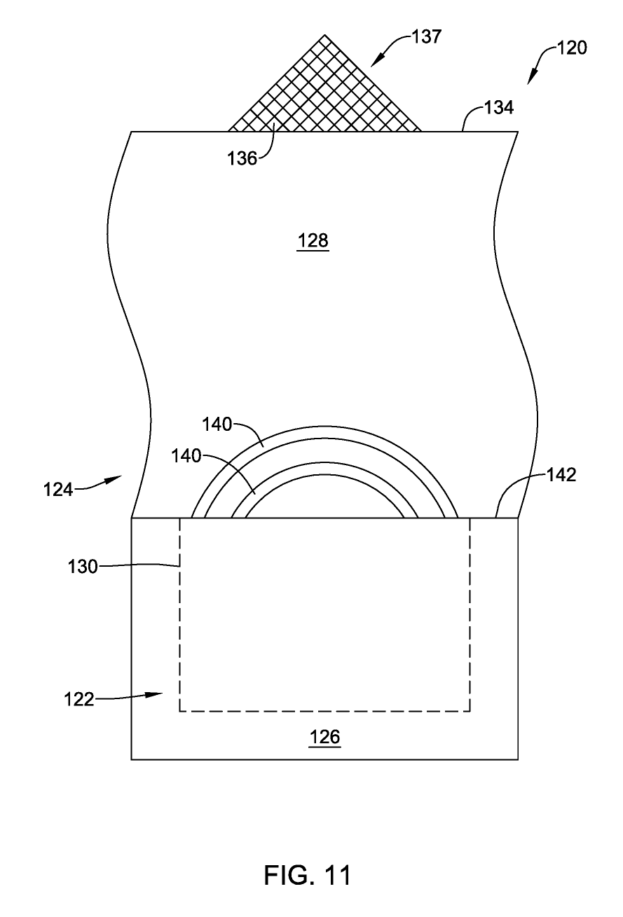

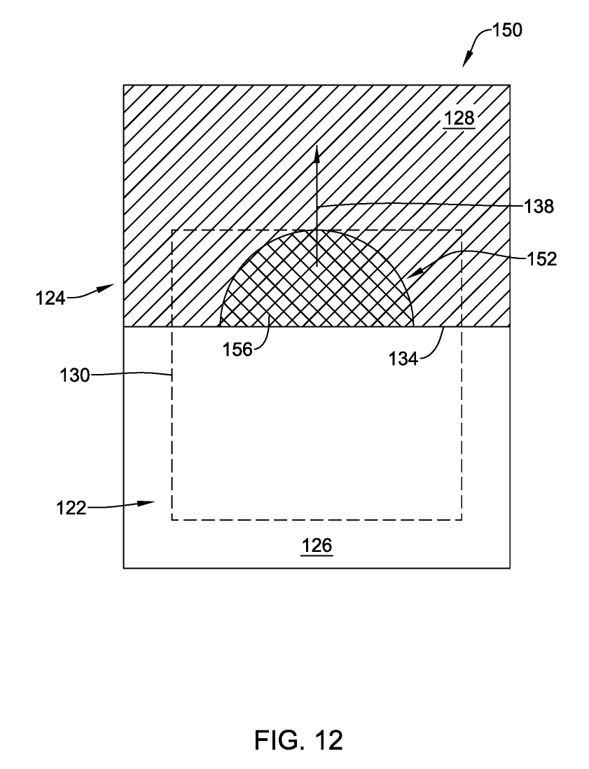

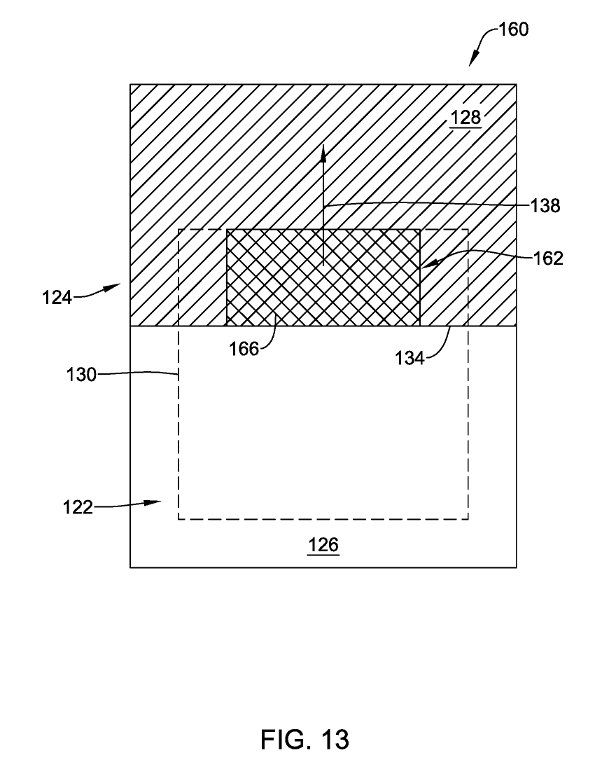

FIG. 10 through FIG. 13 provide illustrative but non-limiting examples of medical device packaging that may be considered to be Tyvek® pouches, formed by sealing together two sheets or panels of material that includes one sheet of a polymeric material and one sheet that includes a spun polyethylene fiber such as but not limited to the materials available commercially under the Tyvek® name. FIG. 10, FIG. 12 and FIG. 13 provide examples of different configurations or styles of release features that may be used to facilitate opening the pouch while FIG. 11 shows the pouch of FIG. 10 in an opened configuration.

In FIG. 10, a medical device package 120 includes a first package portion 122 and a second package portion 124. In some cases, the first package portion 122 may be considered as being a front package portion while the second package portion 124 may be considered to be a back package portion, but this is not required in all cases. In some cases, the first package portion 122 may include a lower region 126 and an upper region 128. The lower region 126 of the first package portion 122 as well as the second package portion 124 may be formed from a polymeric sheet material. Illustrative polymeric materials include but are not limited to polyethylene. In some cases, the upper region 128 of the first package portion 122 may include a sheet material formed from spun polyethylene. In some instances, the upper region 128 may be configured to permit sterilization gases to flow through the upper region 128 in order to sterilize an interior of the medical device package 120, including but not limited to a medical device 130 disposed within the medical device package 120. The medical device 130 may, for example, be a catheter or a guidewire.

A release feature 132 may be secured at or near a lower edge 134 of the upper region 128. In some cases, the release feature 132 may be formed as part of the upper region 128 or may be separately formed and then subsequently attached. In some cases, the release feature 132 may be formed and/or attached as shown with respect to FIG. 4 through FIG. 6, for example. In order to open the medical device package 120, the release feature 132 may be pulled upward in a direction indicated by an arrow 138 in order to provide access to the medical device 130.

In some cases, the release feature 132 may include a visual indicator 136 secured relative to the release feature 132. The visual indicator 136 may, for example, include a pattern or color that helps to distinguish the release feature 132 from the rest of the upper region 128. In some cases, the visual indicator 136 may be printed or otherwise formed directly on the release feature 32. In some cases, the visual indicator 136 may be secured to the release feature 132. In some instances, the visual indicator 136 may include a textural component, such as raised characters or a raised pattern that helps a user locate the release feature 132. The textural component may be formed by adhering a raised feature onto the release feature 132. In some cases, the textural component may be added by processing the release feature 132, such as but not limited to embossing.

In some cases, the release feature 132 has a first dimension that is in the range of about 1 inch to about 3 inches and a second dimension orthogonal to the first dimension that is in the range of about 1 inch to about 3 inches. In some instances, the first dimension and the second dimension may each be in the range of about 1 inch to about 2 inches. It will be appreciated that the release feature 132 has dimensions that enable the release feature 132 to be easily grasped between thumb and index finger. FIG. 11 shows the results of opening the medical device package 120 by pulling upward on the release feature 132. Several coils 140 of the medical device 130 may be seen extending upward from an upper edge 142 of the lower region 126. It will be appreciated that an individual within a sterile field would then be able to remove the medical device 130 from the medical device package 120 without touching or otherwise contacting the non-sterile exterior of the medical device package 120

In FIG. 10 and FIG. 11, the release feature 132 may be seen as having a triangular shape. FIG. 12 and FIG. 13 illustrate medical device packages having different configuration for the release feature. It will be appreciated that the illustrated configurations are merely illustrative, as other shapes are contemplated as well. In FIG. 12, a medical device package 150 is similar to the medical device package 120 shown in FIG. 10 and FIG. 11, although the medical device package 150 has a release feature 152 having a rounded or semicircular profile. In some cases, the release feature 152 may be formed as part of the upper region 128 or may be separately formed and subsequently secured relative to the upper region 128. The release feature 152 may be pulled upward, in a direction indicated by the arrow 138, in order to open the medical device package 150.

In some cases, the release feature 152 may include a visual indicator 156 secured relative to the release feature 152. The visual indicator 156 may, for example, include a pattern or color that helps to distinguish the release feature 152 from the rest of the upper region 128. In some cases, the visual indicator 156 may be printed or otherwise formed directly on the release feature 32. In some cases, the visual indicator 156 may be secured to the release feature 152. In some instances, the visual indicator 156 may include a textural component, such as raised characters or a raised pattern that helps a user locate the release feature 152. The textural component may be formed by adhering a raised feature onto the release feature 152. In some cases, the textural component may be added by processing the release feature 152, such as but not limited to embossing.

In FIG. 13, a medical device package 160 is similar to the medical device package 150 shown in FIG. 12, although the medical device package 160 has a release feature 162 having a rectilinear profile. In some cases, the release feature 162 may be formed as part of the upper region 128 or may be separately formed and subsequently secured relative to the upper region 128. The release feature 162 may be pulled upward, in a direction indicated by the arrow 138, in order to open the medical device package 160.

In some cases, the release feature 162 may include a visual indicator 166 secured relative to the release feature 162. The visual indicator 166 may, for example, include a pattern or color that helps to distinguish the release feature 162 from the rest of the upper region 128. In some cases, the visual indicator 166 may be printed or otherwise formed directly on the release feature 32. In some cases, the visual indicator 166 may be secured to the release feature 162. In some instances, the visual indicator 166 may include a textural component, such as raised characters or a raised pattern that helps a user locate the release feature 162. The textural component may be formed by adhering a raised feature onto the release feature 162. In some cases, the textural component may be added by processing the release feature 162, such as but not limited to embossing.

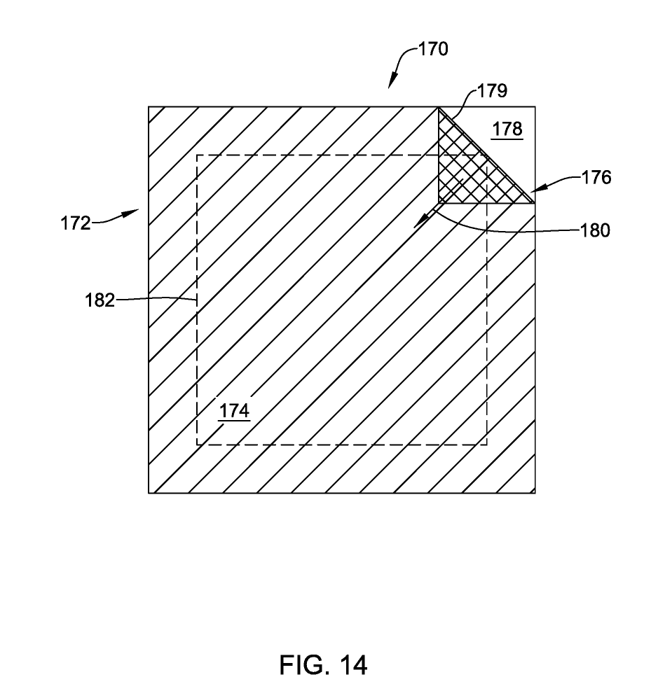

FIG. 14 through FIG. 19 provide illustrative but non-limiting examples of medical device packaging that may be formed by sealing together a sheet of a polymeric material and a sheet formed of a spun polyethylene fiber such as but not limited to the materials available commercially under the Tyvek® name. FIG. 14 through FIG. 19 show examples of medical device packages in which a front panel is formed of a polymeric sheet material while a back panel is formed of the spun polyethylene fiber material. These medical device packages may be opened from the back side. FIG. 14 is a schematic illustration of a medical device package 170.

In FIG. 170, the medical device package 170 includes a first package portion 172 and a second package portion 144. In some cases, the first package portion 172 may be considered as being a front package portion while the second package portion 174 may be considered to be a back package portion, but this is not required in all cases. In some cases, at least some of the first package portion 172 may be adhesively secured around its perimeter to the second package portion 174. In some cases, the second package portion 174 may have a corner folded over to form a release feature 176 and to expose a corner of the first package portion 172 to form a grasping feature 178. It will be appreciated that the medical device package 170 may be opened by grasping the release feature 176 between the thumb and index finger of one hand and pulling in a direction indicated by an arrow 180 while also grasping the grasping feature 178 between the thumb and index finger of another hand, for example, to expose a medical device 182 such as but not limited to a guidewire or a catheter.

In some cases, the release feature 176 may include a visual indicator 179 secured relative to the release feature 20. The visual indicator 179 may, for example, include a pattern or color that helps to distinguish the release feature 176 from the rest of the first package portion 12. In some cases, the visual indicator 179 may be printed or otherwise formed directly on the release feature 176. In some cases, the visual indicator 179 may be secured to the release feature 176. In some instances, the visual indicator 179 may include a textural component, such as raised characters or a raised pattern that helps a user locate the release feature 176. The textural component may be formed by adhering a raised feature onto the release feature 176. In some cases, the textural component may be added by processing the release feature 176, such as but not limited to embossing.

In some cases, the release feature 176 has a first dimension that is in the range of about 1 inch to about 3 inches and a second dimension orthogonal to the first dimension that is in the range of about 1 inch to about 3 inches. In some instances, the first dimension and the second dimension may each be in the range of about 1 inch to about 2 inches. It will be appreciated that the release feature 176 has dimensions that enable the release feature 176 to be easily grasped between thumb and index finger.

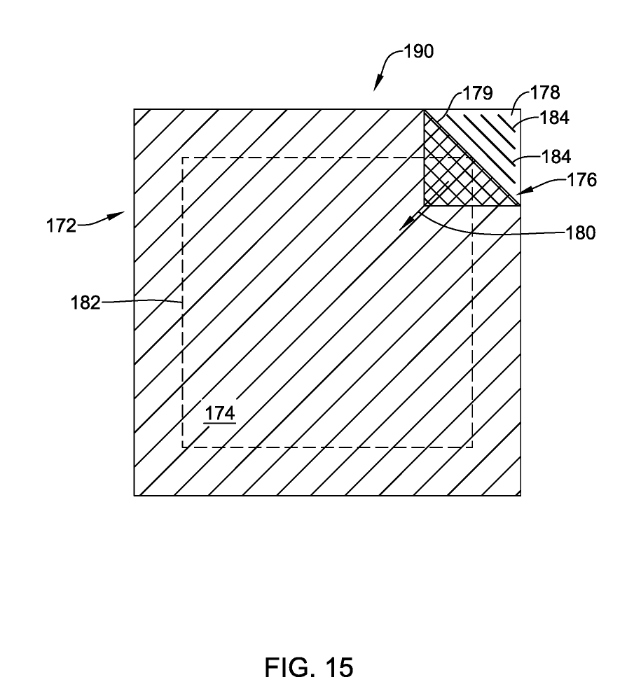

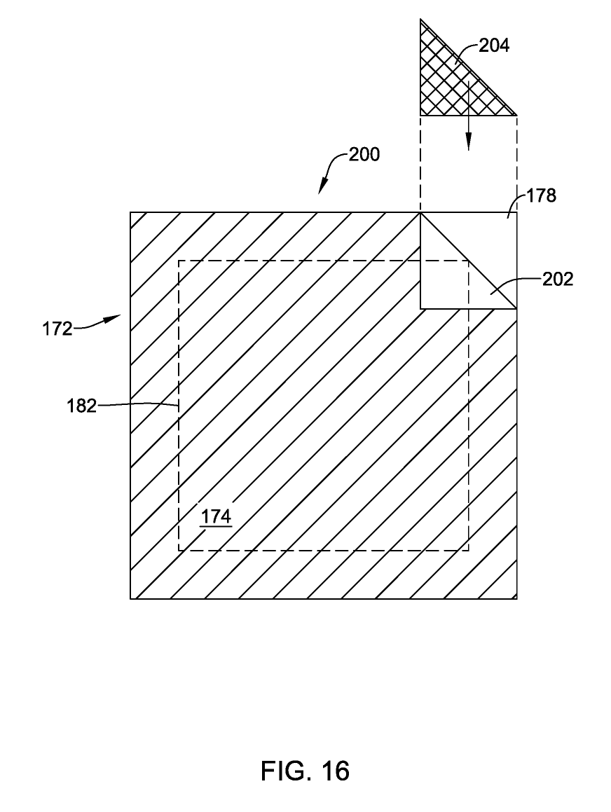

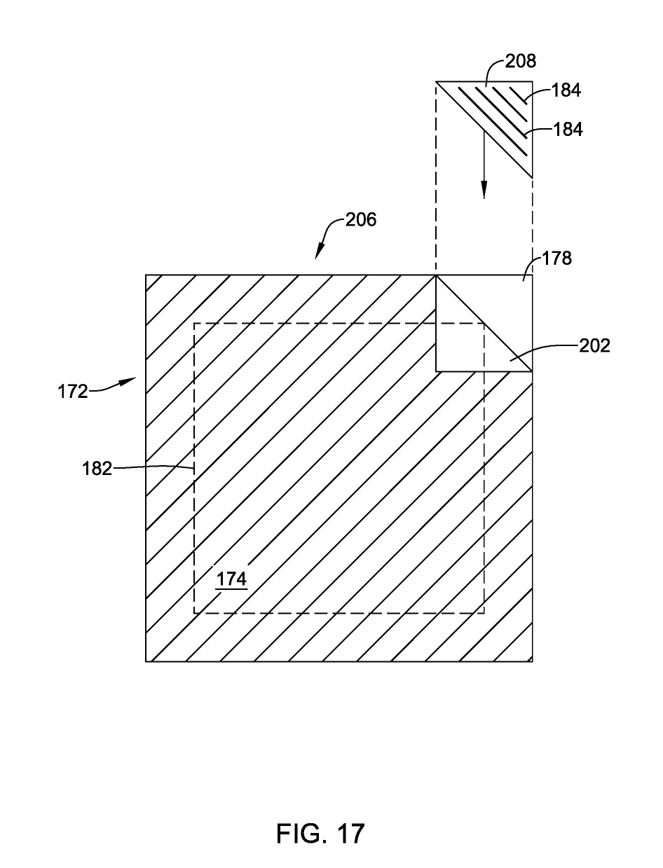

Turning to FIG. 15, in some cases the grasping feature 178 may itself include visual and/or textual features. In some cases, as illustrated, the grasping feature 178 includes several raised features 184 that may facilitate a user more easily gripping the grasping feature 178. In some cases, the raised features 184 may also provide a visual indicator by being a different color than the rest of the grasping feature 178, for example. The raised features 184 may be formed in place on the grasping feature 178, such as by repeatedly crimping the grasping feature 178 or perhaps by subjecting the grasping feature 178 to a crimping press, for example. In some cases, as shown for example in FIG. 16 and FIG. 17, visual and/or textual features may be separately formed and then secured in place relative to the medical device packaging.

FIG. 16 shows a medical device package 200 in which a corner of the second package portion 174 has been folded over to form a flap 202. A substrate 204, which may include visual and/or textual features, may be positioned relative to the flap 202 and may be adhesively or otherwise secured to the flap 202 to form the release feature 176 shown in FIG. 14 and FIG. 15. Similarly, FIG. 17 shows a medical device package 206 in which a substrate 208 bearing the raised features 184 may be positioned relative to the grasping feature 178 and may be adhesively or otherwise secured in place to make the grasping feature 178 easier to see and/or easier to grasp.

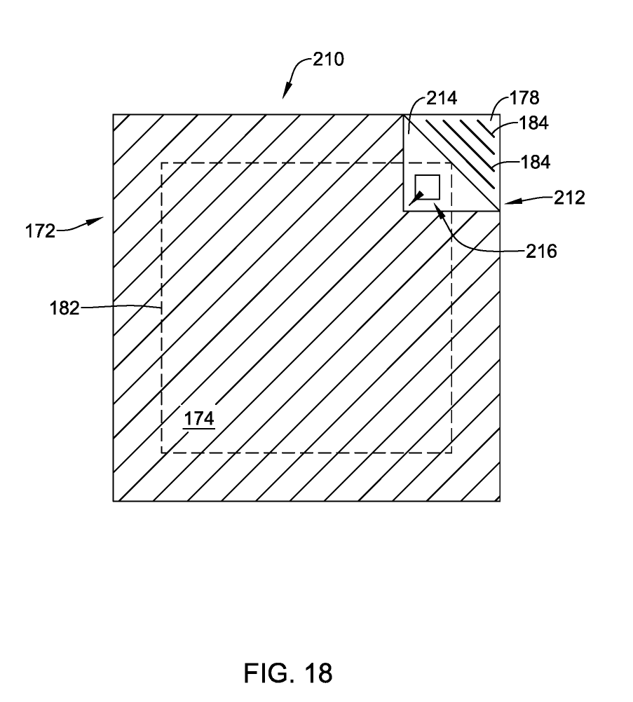

FIG. 18 shows a medical device package 210 including a release feature 212 that is formed by bending over a corner of the second package portion 174 to form a flap 214. A graphical icon 216 is printed onto the flap 214 or is otherwise formed and secured relative to the flap 214 to provide an indication to the user as to how to open the medical device package 210. The grasping feature 178 of the first package portion 172 may be seen as including the raised features 184 that provide a textual and/or visual indication of where to grasp the first package portion 172 in order to open the medical device packing 210.

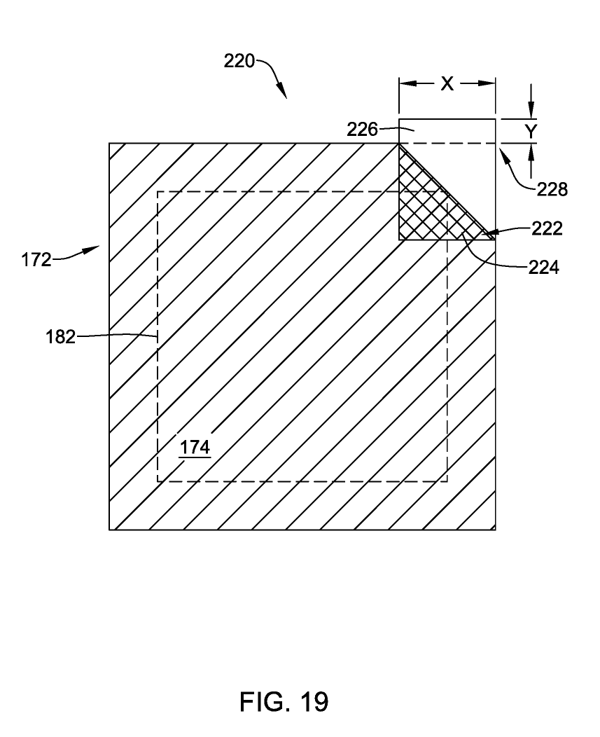

FIG. 19 shows a medical device package 220 including a release feature 222 bearing a visual indicator 224. In some cases, the first package portion 172 includes an extended portion 226 that provides an enlarged grasping portion 228. In some cases, the extended portion 226 may have a rectilinear profile denoted by a width x and a height y. In some cases, x may vary from ½ inch to 3 inches. In some cases, x may vary from 1 inch to 2 inches. In some cases, y may vary from ½ inch to 3 inches. In some instances, y may vary from 1 inch to 2 inches. While the extended portion 226 is illustrated as rectilinear, in some cases the extended portion 226 may be substantially rectilinear with one or two corners rounded over, for example. In some cases, the extended portion 226 may have a curved shape.

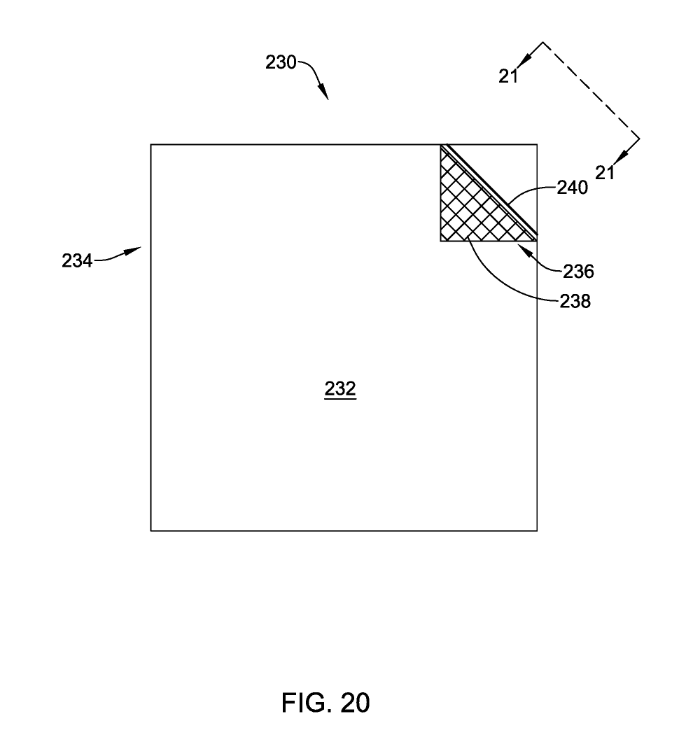

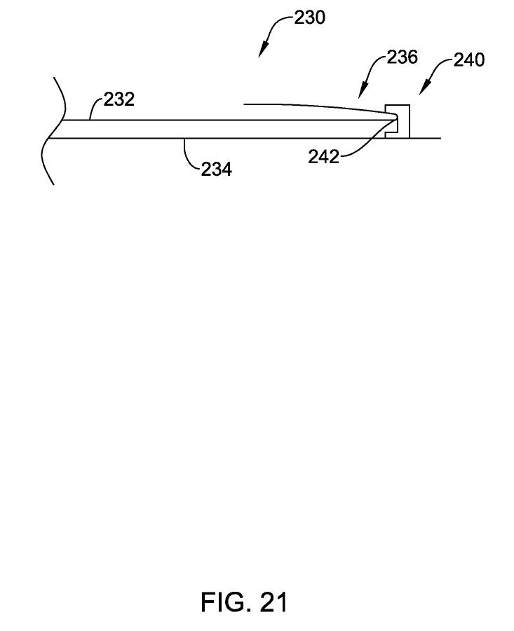

FIG. 20 shows a medical device package 230 and FIG. 21 shows a corner view thereof taken along line 21-21 of FIG. 20. The medical device package 230 includes a first package portion 232 and a second package portion 234. In some cases, as illustrated, a corner of the first package portion 232 may be folded over to form a release feature 236. In some cases, the release feature 236 may include a visual identifier 238. In some instances, in order to help prevent accidental engagement of the release feature 236, a clip 240 may be disposed proximate an apex 242 of the release feature 236. The clip 240, which may for example be adhesively secured to the medical device package 230 or may alternatively be frictionally fit over the apex 242, may provide some resistance to engaging the release feature 236.

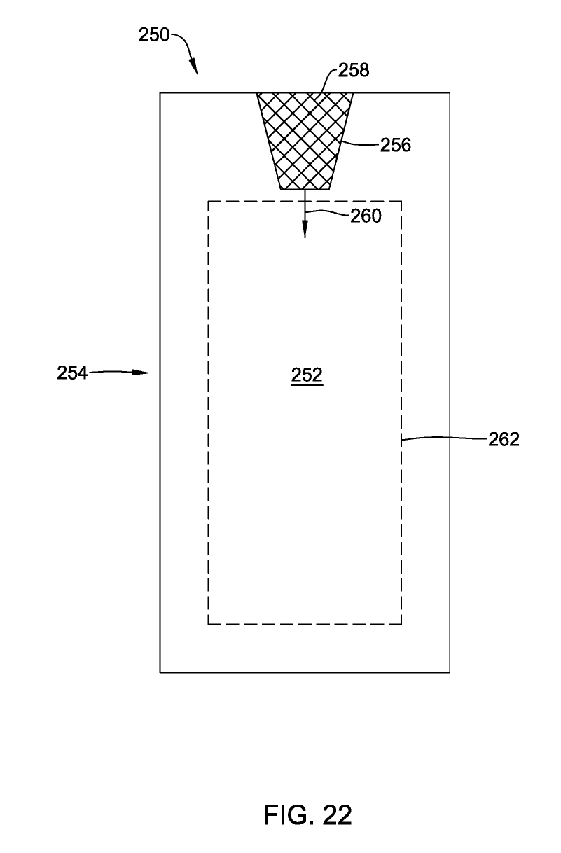

FIG. 22 shows a medical device package 250 that includes a first package portion 252 and a second package portion 254. A release feature 256 may be secured relative to the first package portion 252 such that pulling the release feature 256 in a direction indicated by an arrow 260 may separate the first package portion 252 from the second package portion 254 in order to provide access to a medical device 262 that is disposed within the medical device package 250. In some cases, the medical device 262, which is shown schematically, may for example be a guide catheter or introducer sheath. In some cases, the release feature 256 includes a visual indicator 258, as discussed previously with respect to other Figures.

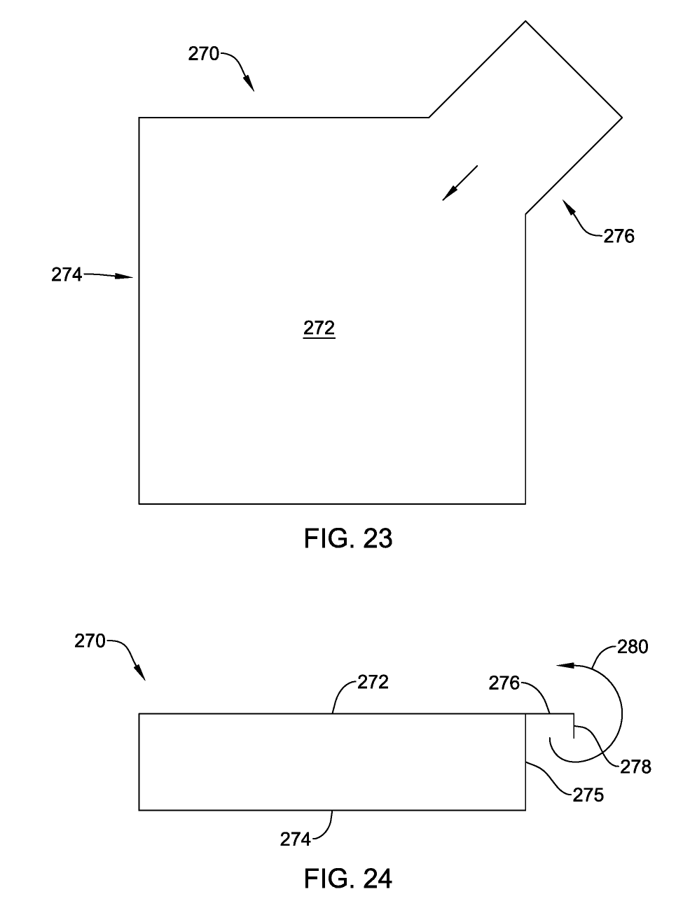

FIG. 23 shows a medical device package 270 while FIG. 24 shows a side view thereof. The medical device package 270 includes a first package portion 272 and a second package portion 274. In some cases, the first package portion 272 is formed of a sheet of a polymeric material or a sheet of a spun polyethylene fiber material such that available commercially under the TYVAK® name. In some cases, the second package portion 274 may be a polymeric tray. The polymeric tray may, for example, be a thermoformed polymeric tray formed of PVC (polyvinyl chloride) or PET (polyethylene terephthalate). While shown schematically, in some cases the second package portion 274 may be contoured to fit and better secure a medical device (not illustrated) within the medical device package 270.

In some cases, the first package portion 272 includes a release feature 276. While the release feature 276 is shown as extending from a corner of the first package portion 272, this is not required. In some cases, the release feature 276 may, for example, extend along one side of the first package portion 272. As seen in FIG. 24, the release feature 276 extends outwardly from a perimeter 275 of the second package portion 274. In some cases, the release feature 276 may include a tab 278 that extends downwardly and provides a feature for a user to grasp and pull upwardly in a direction indicated by an arrow 280 to separate the first package portion 272 from the second package portion 274.

It will be appreciated that a variety of different materials may be used in forming the medical device packages described herein. In some embodiments, for example, the medical device packages may include any suitable polymeric material, including biocompatible materials such as polyurethane or silicone. Other suitable polymers include but are not limited to polytetrafluoroethylene (PTFE), ethylene tetrafluoroethylene (ETFE), fluorinated ethylene propylene (FEP), polyoxymethylene (POM, for example, DELRIN® available from DuPont), polyether block ester, polyurethane (for example, Polyurethane 85A), polypropylene (PP), polyvinylchloride (PVC), polyether-ester (for example, ARNITEL® available from DSM Engineering Plastics), ether or ester based copolymers (for example, butylene/poly(alkylene ether) phthalate and/or other polyester elastomers such as HYTREL® available from DuPont), polyamide (for example, DURETHAN® available from Bayer or CRISTAMID® available from Elf Atochem), elastomeric polyamides, block polyamide/ethers, polyether block amide (PEBA, for example available under the trade name PEBAX®), ethylene vinyl acetate copolymers (EVA), silicones, polyethylene (PE), Marlex high-density polyethylene, Marlex low-density polyethylene, linear low density polyethylene (for example REXELL®), polyester, polybutylene terephthalate (PBT), polyethylene terephthalate (PET), polytrimethylene terephthalate, polyethylene naphthalate (PEN), polyetheretherketone (PEEK), polyimide (PI), polyetherimide (PEI), polyphenylene sulfide (PPS), polyphenylene oxide (PPO), poly paraphenylene terephthalamide (for example, KEVLAR®), polysulfone, nylon, nylon-12 (such as GRILAMID® available from EMS American Grilon), perfluoro(propyl vinyl ether) (PFA), ethylene vinyl alcohol, polyolefin, polystyrene, epoxy, polyvinylidene chloride (PVdC), poly(styrene-b-isobutylene-b-styrene) (for example, SIBS and/or SIBS 50A), polycarbonates, ionomers, biocompatible polymers, other suitable materials, or mixtures, combinations, copolymers thereof, polymer/metal composites, and the like.

Those skilled in the art will recognize that the present disclosure may be manifested in a variety of forms other than the specific embodiments described and contemplated herein. Accordingly, departure in form and detail may be made without departing from the scope and spirit of the present disclosure as described in the appended claims.

What is claimed is:

1. A medical device package configured to accommodate a medical device therein, comprising:
a back package portion;
a front package portion releasably secured to the back package portion;
the front package portion including:
a release feature secured to the front package portion;
a visual indicator coupled to the release feature, the visual indicator facilitating easy identification of the release feature;
the back package portion configured to provide a holding feature to facilitate holding onto the back package portion while pulling on the release feature in order to peel the front package portion away from the back package portion in order to provide access to the medical device disposed within the medical device package.

2. The medical device package of claim 1, further comprising a medical device disposed within the medical device package.

3. The medical device package of claim 2, wherein the medical device comprises a guidewire or a catheter.

4. The medical device package of claim 1, wherein the front package portion further comprises a textured surface coupled to the release feature in order to facilitate grasping the release feature.

5. The medical device package of claim 1, wherein the back package portion further comprises a textured surface disposed proximate the release feature of the front package portion in order to facilitate holding the back package portion when pulling on the release feature.

6. The medical device package of claim 1, wherein the back package portion further comprises a region of the back package portion extending beyond a periphery of the front package portion.

7. The medical device package of claim 1, wherein the front package portion comprises a polymeric panel, and the release feature comprises a corner of the polymeric panel folded back over itself to form a flap.

8. The medical device package of claim 7, wherein the flap is secured in place relative to the front package portion with an adhesive disposed between the flap and the front package panel.

9. The medical device package of claim 7, wherein the flap is pressed into place relative to the front package portion by crimping the flap.

10. The medical device package of claim 7, further comprising a clip that is configured to hold the flap down, the clip secured relative to the front package portion.

11. The medical device package of claim 1, wherein the back package portion comprises a polymeric panel.

12. The medical device package of claim 1, wherein the back package portion comprises a polymeric tray.

13. A package for holding a medical device, the medical device sterilizable while within the package, the package comprising:
a first package portion;
a second package portion, the second package portion releasably secured to the first package portion;
the first package portion and the second package portion in combination defining a space within which the medical device may be disposed;
at least one of the first package portion and the second package portion including a release feature facilitating separation of the first package portion from the second package portion in order to provide access to the medical device, the release feature providing a visual indication of how to separate the first package portion from the second package portion.

14. The package of claim 13, wherein the release feature further provides an element to facilitate grasping at least one of the first package portion and the second package portion.

15. The package of claim 13, wherein the release feature further provides a first element to facilitate grasping the first package portion and a second element to facilitate grasping the second package portion.

16. The package of claim 13, wherein at least one of the first package portion and the second package portion comprise an aluminum foil.

17. The package of claim 13, wherein at least one of the first package portion and the second package portion comprise a polymeric panel.

18. The package of claim 13, wherein at least one of the first package portion and the second package portion comprise spun polyethylene fibers (reference to Tyvek).

19. A package for holding an article, comprising:
a first package portion;
a second package portion, the second package portion releasably secured to the first package portion;
the first package portion and the second package portion in combination defining a space within which the article may be disposed;
at least one of the first package portion and the second package portion including a feature facilitating separation of the first package portion from the second package portion in order to provide access to the article, the feature providing a visual indication of how to separate the first package portion from the second package portion.

20. The package of claim 19, wherein the feature further provides an element to facilitate grasping at least one of the first package portion and the second package portion.
